(19) United States
(12) Patent Application Publication
(10) Pub. No.: US 2009/0319481 A1
(43) Pub. Date: Dec. 24, 2009

(54) FRAMEWORK FOR AGGREGATING INFORMATION OF WEB PAGES FROM A WEBSITE

(75) Inventors: Krishna Prasad Chitrapura, Bangalore (IN); Krishna Leela Poola, Bangalore (IN); Mahesh Tiyyagura, Hyderabad (IN)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: Yahoo! Inc., Sunnyvale, CA (US)

(21) Appl. No.: 12/141,232

(22) Filed: Jun. 18, 2008

(51) Int. Cl. G06F 7/06; G06F 17/30

(52) U.S. Cl. 707/3; 707/E17.108

(57) ABSTRACT

The present invention is directed towards systems and methods for extending media annotations using collective knowledge. The method according to one embodiment of the present invention comprises receiving a plurality of content items and associated annotations. The method further normalizes the plurality of associated annotations and calculates pair frequencies for the plurality of associated annotations. The method then retrieves a plurality of alternative annotations and provides the plurality of alternative annotations.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

Embodiments of the invention disclosed herein relates generally to providing a framework for aggregating information of web pages from a web site. More specifically, embodiments of the present invention are directed towards systems, methods and computer program products for aggregating a plurality of features across a given website domain and providing an aggregate feature set for the domain.

### BACKGROUND OF THE INVENTION

The aggregation of information on the Internet is an increasingly important task. Given the size and breadth of the Internet, however, aggregation is an equally difficult task. Indeed, as the Internet expands exponentially, the problem of aggregating data efficiently and effectively becomes increasingly difficult.

Aggregation of data on the Internet has numerous advantages. For example, aggregation of data across a subset of a website helps describe those pages with little analyzable content (e.g., images, Flash, etc.). Aggregation also allows for predictions to be made on unseen pages on the basis of the analysis of seen pages, thus allowing services to retrieve the most relevant and newest content available. For example, a search engine employing aggregation may be able to retrieve unseen pages in response to a user query, which an aspect of search engines unable to be addressed with current indexing techniques. Finally, aggregation has the advantages of working with multiple units of data, as opposed to desegregation, which works at the level of an individual unit. By using aggregation one can make determinations and predictions about a given content item given the context of the content item.

Thus, there is a need in the art for systems, methods and computer program products that provide a framework for aggregating information of web pages from a web site. Embodiments of the presently described invention address the advantages previously described and apply a customizable framework for exploiting the features of webpages in the context of information retrieval on the Internet.

### SUMMARY OF THE INVENTION

The present invention is directed towards systems, methods and computer program products for providing a framework for aggregating information of webpages from a website. The method of the present invention comprises selecting a website and extracting one or more features from web pages associated with the website. In one embodiment, the method may further comprise constructing a sitemap associated with a given website.

The method aggregates the extracted features for the web pages. In a first embodiment, the feature set may comprise one or more numerical features, such as the number of in-links or an adult score. In a second embodiment, the feature set may comprise one or more categorical features, such as a classification or keyword match. In a third embodiment, the feature set comprises one or more rule-based features, such as a URL matching algorithm, which may analyze substrings of URLs. The method may store the aggregated features, which may be on a per web site basis.

The system of the present invention comprises one or more client devices coupled to a network and a content server coupled to the network, the content server operative to transmit and received data from the client devices. In one embodiment, the content server is operative to construct a sitemap associated with a given website. In a second embodiment, the content server is operative to reduce the noise of the aggregated features.

The system may comprise a crawler operative to selecting a website and a feature store operative to store a feature set comprising one or more features. In a first embodiment, the feature set may comprise one or more numerical features, such as the number of in-links or adult score. In a second embodiment, the feature set may comprise one or more categorical features, such as a classification or keyword match. In a third embodiment, the feature set comprises one or more rule-based features, such as a URL matching algorithm, which may analyze substrings of the URL.

The system may also comprise an aggregation module operative to load the feature set, extract the plurality of features from a plurality of webpages associated with the website and aggregate the extracted features for the plurality of web pages, as well as a content store operative to store the aggregated features.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a block diagram depicting a system for generating an aggregated feature set according to one embodiment of the present invention;

FIG. 2 presents a flow diagram illustrating a method for generating an aggregated feature set according to one embodiment of the present invention;

FIG. 3A provides a flow diagram illustrating a method for extracting numerical features from a selected webpage according to one embodiment of the present invention;

FIG. 3B provides a flow diagram illustrating a method for aggregating categorical features across a website according to one embodiment of the present invention; and

FIG. 3C illustrates a flow diagram illustrating a method for aggregating rules across a website according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

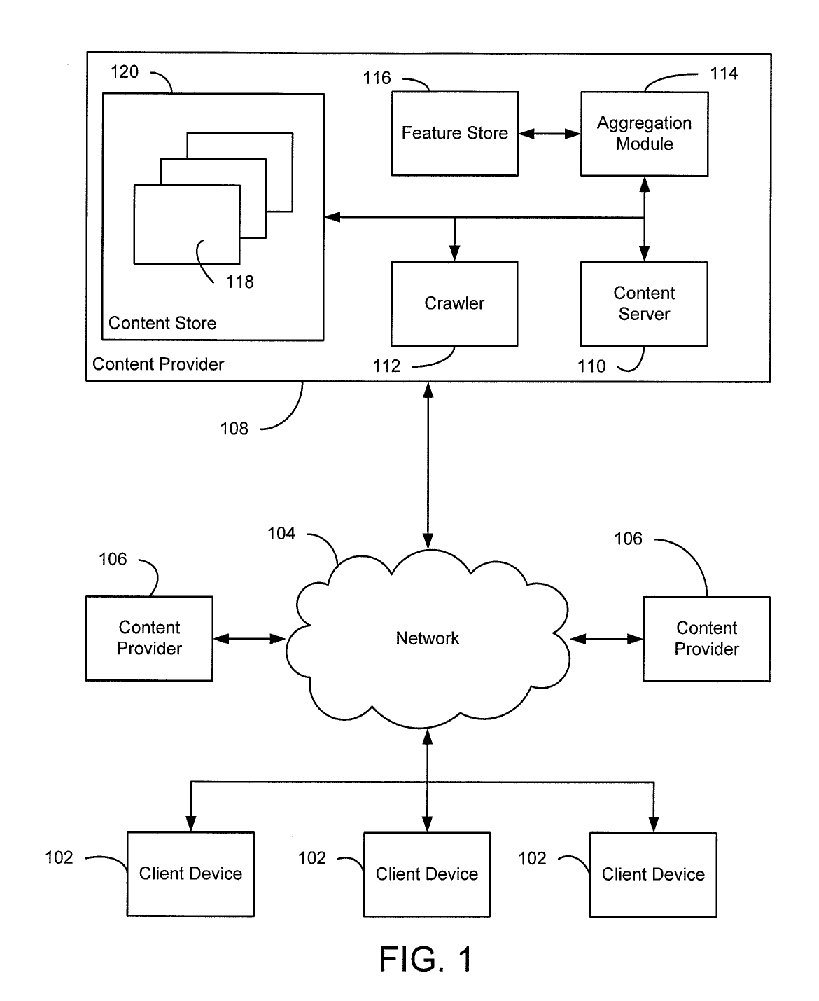

FIG. 1 presents a block diagram depicting a system for generating an aggregated feature set according to one embodiment of the present invention. According to the embodiment that FIG. 1 illustrates, a plurality of client devices 102 are communicatively coupled to a network 104, which may include a connection to one or more local or wide area networks, such as the Internet. A given client device 102 is in communication over the network 104 with a content provider 108. According to the present embodiment, a content provider 102 comprises a content server 110 operative to receive data requests from a given client device 102 and return appropriate or otherwise relevant data in response to the received data requests. In addition to a content server 110, a content provider 108 further comprises crawler 112.

Crawler 112 is operative to analyze one or more web pages located on a given content provider 106. In one embodiment, crawler 112 may partition a crawling process to analyze a set of given webpages associated with a given site. For example, a given website may be identified as “www.example.com”. The crawler may use a regular expression such as “*.example.com” to crawl all pages for the website and any alternative subdomains such as “www2.example.com”, “sports.example.com”, “shopping.example.com”, etc. Alternatively, crawler 112 may intelligently divide a given website into subject-specific sites. That is, “sports.example.com” may be classified as a first website and “shopping.example.com” may be classified as a second website, although both are located within the same “example.com” domain.

Crawler 112 is operative to store information regarding websites 118 within a content store 120 at the content provider 108. In one embodiment, information regarding websites 118 may comprise records in a relational database, or any alternative indexing database schema known in the art, e.g., an object-oriented database, a hybrid object-relational database, a flat file data store such as a CSV table, etc. Alternatively, or in conjunction with the foregoing, crawler 112 may further be operative to receive additional data regarding the websites and web pages including, but not limited, to information known in the art retrieved by search engine crawlers. Content store 120 may enable content provider 108 to update information related to individual webpages, entire websites or a combination of both, such as logical groupings of webpages within a single website.

Crawler 112 is further coupled to an aggregation module 114 at the content provider 108 and operative to generate aggregate features for a given website. Aggregation module 114 is couple to a feature store 116, operative to store one or more features utilized to aggregate information across a plurality of webpages. In one embodiment, aggregation module 114 may receive one or more web pages corresponding to a logical grouping of a website's pages. Aggregation module 114 may load the aggregated features from feature store 116, analyzes the plurality of webpages and generate a feature vector for the given plurality of pages. In one embodiment, a feature vector may comprise a vector operative to store a plurality of feature values in a structure such as an associative array. For example, a value stored within a feature vector may comprise a key/value pair such as “inlinks=10” indicating the number of inlinks for a given webpage is 10. The aggregation module 114 may store the given feature vector within content store 120, e.g., in association with the web pages. In one embodiment, content server 110 may further be operative to perform administrative tasks, such as cleaning up noise in the returned aggregate features or building a sitemap for a given website.

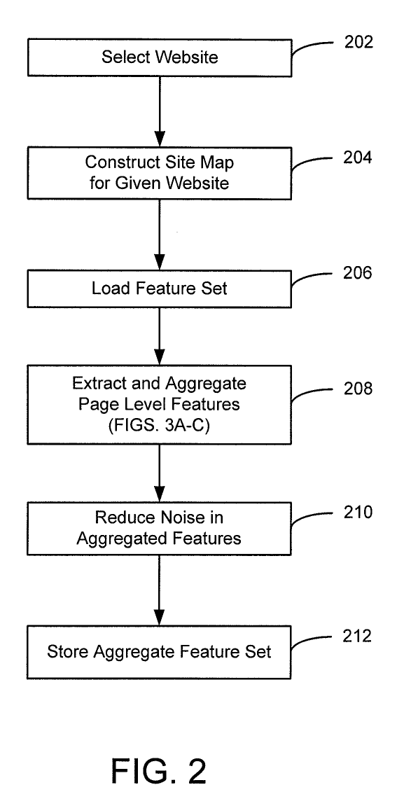

FIG. 2 presents a flow diagram illustrating a method for generating an aggregated feature set according to one embodiment of the present invention. As FIG. 2 illustrates, the method 200 selects a website, step 202. In one embodiment, selecting a website may comprise selecting a website domain by providing a URL, for example, www.example.com. In an alternative embodiment, selecting a website may comprise selecting a subset of a website domain according to a pattern matching rule. For example, “sports.example.com” and “music.example.com” may comprise two separate websites.

The method 200 may construct a site map for the selected website, step 204. In one embodiment, a site map is built dynamically on the basis of link analysis of a currently selected website. For example, an automated program may crawl a given web site to determine a structure for the web site. Alternatively, a site map may be retrieved from the selected website and the site map may conform to a predetermined site map standard.

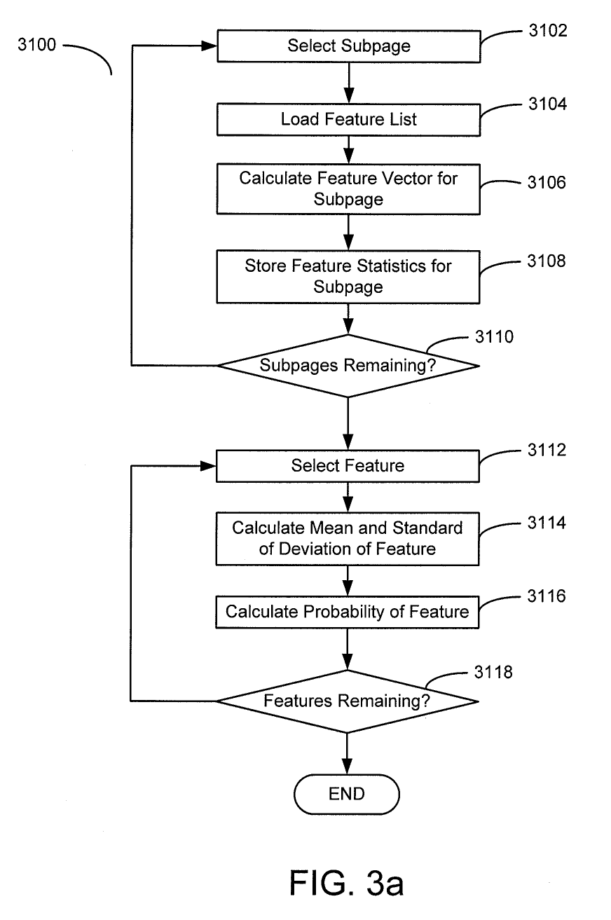

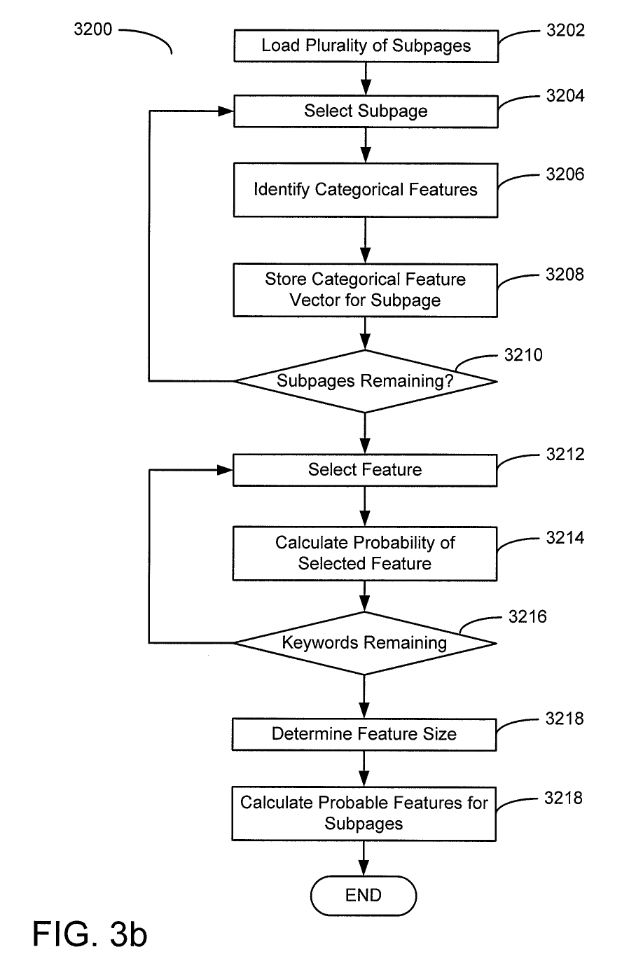

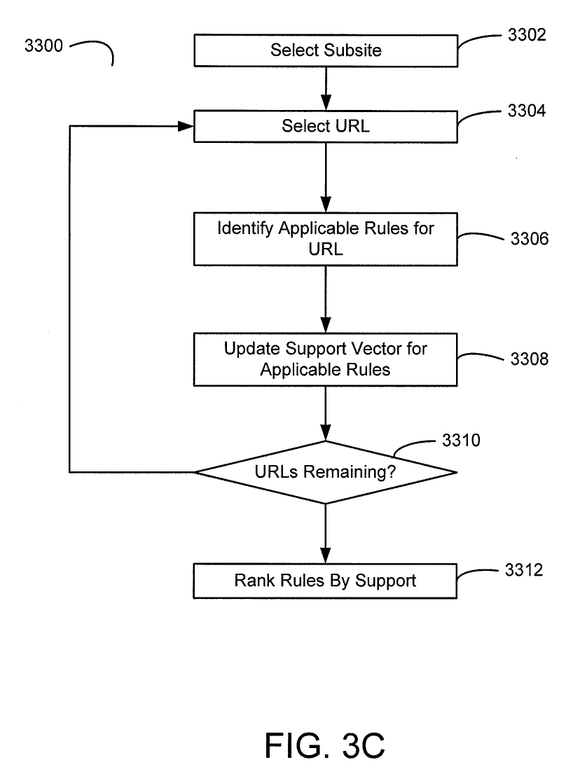

The method 200 continues by loading a feature set for a given website, step 206. In one embodiment, a feature set may comprise a list of features against which to analyze a web page. For example, a feature set may include numerical features such as the number of in-links, an adult score or any number of features described numerically. Alternatively, or in conjunction with the foregoing, a feature set may comprise a list of categorical features, such as a page classification, keywords, etc. Still further, a feature set may comprise a list of rules applicable to a given webpage. For example, a rule may comprise analyzing a URL to determine if various substrings within the URL match a given rule. Types of features are described more fully with respect to FIGS. 3A through 3C.

After loading a feature set, the method 200 may extract and aggregate page-level features, step 208. In one embodiment, the method 200 aggregates one or more features across one or more web pages associated with a given website. In accordance with this embodiment, a feature vector may be returned that describes the selected website. Extracting and aggregating page-level features are discussed in detail with respect to FIGS. 3A through 3C.

After extracting and aggregating page-level features, the method 200 may reduce noise within the aggregated features, step 210. In one embodiment, a Bayesian network with the same structure as generated in step 204 may be used to remove noise from the aggregated features. In this embodiment, features are encoded as prior probabilities and conditional independence imposed by the hierarchal structure of the site map may be used to compute the posterior probabilities on the tree. Additionally, the method 200 may derive conditional probability semantics between parents and children within the site map according to alternative models, such as UNITS or Darwin taxonomy. UNITS is described in greater detail in commonly owned U.S. Pat. No. 7,051,023 entitled “SYSTEMS AND METHODS FOR GENERATING CONCEPT UNITS FROM SEARCH QUERIES,” and filed on Nov. 17, 2003 under attorney docket number 600189-384, the disclosure of which is hereby incorporated by reference in its entirety.

The method 200 may store the generated feature set, step 212. In one embodiment, the method 200 stores a generated feature set in a database along with information identifying the selected website, e.g., on a per website basis. In an alternative embodiment, the method 200 stores the generated feature set in an ancillary database and associates the feature set with the selected website via an indexing mechanism.

FIG. 3A presents a flow diagram illustrating a method for extracting numerical features from a selected webpage according to one embodiment of the present invention. The method 3100 first selects a subpage of a given website, step 3102. In one embodiment, selecting a subpage may comprise selecting a subpage from a sitemap, which may be a pre-generated sitemap. In the illustrated embodiment, a subpage may comprise a webpage located lower within a website hierarchy than a selected webpage. For example, a selected webpage “http://www.example.com/sports/football” may contain a plurality of subpages such as “http://www.example.com/sports/football”, “http://www.example.com/sports/football/euro2008”, or “http://www.example.com/sports/football/match?id=1234.”

The method 3100 continues by loading a feature list, step 3104. In one embodiment, a feature list may comprise one or more numerical features describing a web page. For example, a feature list may comprise numerical features such as the number of page in-links, the adult score, etc. As illustrated, a numerical feature may be a simple count of a particular aspect of a web page, such as the number of in-links, or maybe a more sophisticated value determined by a more sophisticated algorithm (e.g., an adult score calculated by a ancillary classifier).

The method 3100 calculates a feature vector for the selected subpage, the feature vector comprising values retrieved from the feature list, step 3106. In one embodiment, a generated feature vector may comprise an N-dimensional vector for storing numerical data related to a given web page. In one embodiment, the fields of the generated feature vector may be populated on the basis of the features present within the feature list, which may be the feature list retrieved in step 3104. After calculating a feature vector, the method 300 may store the feature vector associated with a given subpage, step 3108. In one embodiment, a feature vector is stored in a database, or similar data store, along with information regarding the selected subpage, such as a database maintaining an index of one or more web pages. The method 3100 may determine if any received subpages are remaining, step 3110, repeating steps 3102, 3104, 3106, 3108 and 3110 for the remaining subpages.

The remaining steps (3112, 3114, 3116, 3118) are directed towards aggregating the collected features for a given website. In the illustrated embodiment, subpages analyzed in steps 3102, 3104, 3106, 3108 and 3110 are aggregated to determine an aggregate feature set for a given website. Alternative embodiments exist, however, wherein a subset of a given website may be utilized to aggregate features, as described previously.

The method 3100 continues with the selection of a given feature from a list of available features, step 3112. In one embodiment, the selected features may correspond to the feature list retrieved in step 3104. In an alternative embodiment, a feature list comprising a subset of the loaded feature list may be utilized. The method 3100 iterates through the selected features (step 3118) and calculates the mean, standard deviation and the probability of the numerical features, steps 3114 and 3116, respectively.

FIG. 3B presents a flow diagram illustrating a method for aggregating categorical features across a website according to one embodiment of the present invention. The method 3200 that FIG. 3B illustrates involves loading one or more we pages, step 3202, and inspecting one or more subpages associated with the selected pages, step 3204.

Upon selecting a given subpage, the method 3200 inspects the subpage to identify categorical features, step 3206. In one embodiment, identifying a categorical feature comprises a single algorithm, but may also comprise a plurality of algorithms. For example, identifying categorical features may comprise using a classifier to assign a classification label to a given subpage. In a second example, identifying a categorical feature may comprise identifying a plurality of keywords for a given subpage by analyzing the text of a given subpage. After identifying a plurality of categorical features, the method 3200 ma update a categorical feature vector associated with the determined categorical features, step 3208. In one embodiment, updating a categorical feature vector comprises storing the vector in a relational database along with the associated subpage. The method performed in steps 3204, 3206 and 3208 may repeat for any remaining subpages, step 3210.

After collecting one or more categorical features, the method 3200 selects a given feature, step 3212, and calculates the probability of the select feature, step 3214. In one embodiment, the calculated probability corresponds to the probability of the occurrence of the selected feature against subpages analyzed by the method in steps 3204, 3206 and 3208.

FIG. 3C presents a flow diagram illustrating a method for aggregating rules across a website according to one embodiment of the present invention. The method 3300 selects a subsite, step 3302, and inspects one or more URLs associated with the selected subsite, step 3304. In one embodiment, a list of URLs is retrieved some a site map or similar index of URLs. In a first embodiment, a list of URLs comprises a list of URLs associated with a subset of an entire website.

For a given URL, one or more applicable rules may be determined, step 3306. In one embodiment, a rule associated with a URL may comprise information describing the URL. For example, a rule may indicate that a first substring within the URL is a constant across a subsite or that a second substring within the URL is case-insensitive. For example, a subsite containing the URLs “http://www.example.com/sports/baseball/stats?playerid=143&sid=32fsgirg240” and “http://www.example.com/sports/baseball/team?teamid=13&sid=32fsgirg240” may have a first rule indicating the substring “&sid=32fsgirg240” remains constant for that subsite and is associated with a session ID. Alternatively, a subsite containing the URLs “http://www.example.com/sports/baseball/search?q=david+ortiz” and “http://www.example.com/sports/baseball/search?q=Boston+red+sox” may generate a second rule indicating that characters after the string “q=” are case-insensitive and correspond to a query.

After determining one or more rules, the method 3300 updates a support vector associated with the determined rules, step 3308. In one embodiment, updating a support vector may comprise incrementing the number of times a given rule matches a selected URL, thus indicating “support” for a rule as being proportional to the number of URLs matching the rule.

FIGS. 1 through 3C are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for providing a framework for aggregating information of web pages from a website, the method comprising:
selecting a website;
loading a feature set containing a plurality of features;
extracting the plurality of features from a plurality of webpages associated with the website;
aggregating the extracted features for the plurality of webpages; and
storing the aggregated features.

2. The method of claim 1 comprising constructing a sitemap associated with a given website.

3. The method of claim 1 comprising reducing noise of the aggregated features.

4. The method of claim 1 wherein the feature set comprises one or more numerical features.

5. The method of claim 4 wherein numerical features comprise one of: the number of in-links or adult score.

6. The method of claim 1 wherein the feature set comprises one or more categorical features.

7. The method of claim 6 wherein the categorical features comprise one of: a classification or keyword match.

8. The method of claim 1 wherein the feature set comprises one or more rule-based features.

9. The method of claim 8 wherein the rule-based features comprise a URL matching algorithm.

10. The method of claim 9 wherein the rule-matching algorithm analyzes substrings of the URL.

11. The method of claim 1 further operative to perform search ranking based on aggregated features, place contextual advertisements on web pages based on aggregated features or crawl the deep and hidden web with aggregated rules to normalize the discovered URLs.

12. A system for providing a framework for aggregating information of web pages from a website, the system comprising:
a plurality of client devices coupled to a network;
a content server coupled to the network operative to transmit and received data from the client devices;
a crawler operative to selecting a website;
a feature store operative to store a feature set containing a plurality of features;
an aggregation module operative to load the feature set, extract the plurality of features from a plurality of webpages associated with the website and aggregate the extracted features for the plurality of webpages; and
a content store operative to store the aggregated features.

13. The system of claim 12 wherein the content server is operative to construct a sitemap associated with a given website.

14. The system of claim 12 wherein the content server is operative to reduce the noise of the aggregated features.

15. The system of claim 12 wherein the feature set comprises one or more numerical features.

16. The system of claim 13 wherein numerical features comprise one of: the number of in-links or adult score.

17. The system of claim 12 wherein the feature set comprises one or more categorical features.

18. The system of claim 17 wherein the categorical features comprise one of: a classification or keyword match.

19. The system of claim 12 wherein the feature set comprises one or more rule-based features.

20. The system of claim 19 wherein the rule-based features comprise a URL matching algorithm.

21. The system of claim 20 wherein the rule-matching algorithm analyzes substrings of the URL.

22. The system of claim 12 operative to perform search ranking based on aggregated features, place contextual advertisements on web pages based on aggregated features or crawl the deep and hidden web with aggregated rules to normalize the discovered URLs.

23. Computer readable media comprising program code for execution by a programmable processor that instructs the processor to perform a method for providing a framework for aggregating information of web pages from a website, the computer readable media comprising:
program code for selecting a website;
program code for loading a feature set containing a plurality of features;
program code for extracting the plurality of features from a plurality of webpages associated with the website;
program code for aggregating the extracted features for the plurality of webpages; and
program code for storing the aggregated features.

24. The computer readable media of claim 23 comprising program code for constructing a sitemap associated with a given website.

25. The computer readable media of claim 23 comprising program code for reducing noise of the aggregated features.

26. The computer readable media of claim 23 wherein program code for loading the feature set comprises program code for loading one or more numerical features.

27. The method of claim 26 wherein the program code for loading the numerical features comprise program code for loading one of: the number of in-links or adult score.

28. The method of claim 23 wherein the program code for loading the feature set comprises program code for loading one or more categorical features.

29. The method of claim 28 wherein the program code for loading the categorical features comprises program code for loading one of: a classification or keyword match.

30. The method of claim 23 wherein the program code for loading the feature set comprises program code for loading one or more rule-based features.

31. The method of claim 30 wherein program code for loading the rule-based features comprise program code for loading a URL matching algorithm.

32. The method of claim 30 wherein the program code for loading the rule-matching algorithm comprises program code for analyzing substrings of the URL.

33. The method of claim 23 further operative to perform search ranking based on aggregated features, place contextual advertisements on web pages based on aggregated features or crawl the deep and hidden web with aggregated rules to normalize the discovered URLs.
